(19) United States
(12) Patent Application Publication
(10) Pub. No.: US 2017/0058122 A1
(43) Pub. Date: Mar. 2, 2017

(54) Thermoplastic Resin Composition and Molded Article Comprising the Same

(71) Applicant: Lotte Advanced Materials Co., Ltd., Yeosu-si (KR)

(72) Inventor: Jeong Eun PARK, Uiwang-si (KR)

(21) Appl. No.: 15/251,116

(22) Filed: Aug. 30, 2016

(30) Foreign Application Priority Data
Aug. 31, 2015 (KR) 10-2015-0122659

(51) Int. Cl. C08L 69/00

(52) U.S. Cl. CPC C08L 69/00

(57) ABSTRACT

A thermoplastic resin composition and a molded article including the same are disclosed. The thermoplastic resin composition includes about 100 parts by weight of a base resin including about 60% by weight (wt %) to about 85 wt % of a polycarbonate resin and about 15 wt % to about 40 wt % of a polyester resin; and about 10 parts by weight to about 25 parts by weight of wollastonite, wherein the wollastonite has an average particle diameter (D50) of greater than about 10 μm to less than about 15 μm.

### CROSS-REFERENCE TO RELATED APPLICATION

This application claims priority under 35 USC Section 119 to and the benefit of Korean Patent Application No. 10-2015-0122659, filed on Aug. 31, 2015 in the Korean Intellectual Property Office, the entire disclosure of which is incorporated herein by reference.

### FIELD

The present invention relates to a thermoplastic resin composition and a molded article including the same.

### BACKGROUND

Thermoplastic resins exhibit good properties, such as low specific gravity, good moldability, and good impact resistance, as compared with glass or metal, and are useful for housings of electrical/electronic products, automotive interior/exterior materials, and exterior materials for buildings. For example, a blend of a polyester resin and a polycarbonate resin can exhibit both properties of the polyester resin such as high mechanical strength and good moldability and properties of the polycarbonate resin such as good thermal resistance, impact stability and dimensional stability.

Recently, with the trend towards weight reduction of automotive interior/exterior components for improvement in fuel efficiency, there is an increasing need for a material having high impact resistance so as to achieve thickness reduction of a molded article. Also, dimensional stability of a material becomes an important issue corresponding to increase in demand for a large molded article for simplification and integration of components.

However, reduction in amount of fillers in a resin composition for improvement in impact resistance can deteriorate dimensional stability, external appearance, and stiffness.

Therefore, there is a need for a material having good properties in terms of not only impact resistance, but also dimensional stability, external appearance and stiffness.

### SUMMARY OF THE INVENTION

The present invention provides a thermoplastic resin composition that can have good properties in terms of not only impact resistance, external appearance and stiffness, but also dimensional stability, and a molded article including the same.

The thermoplastic resin composition includes about 100 parts by weight of a base resin including about 60% by weight (wt %) to about 85 wt % of a polycarbonate resin and about 15 wt % to about 40 wt % of a polyester resin; and about 10 parts by weight to about 25 parts by weight of wollastonite, wherein the wollastonite has an average particle diameter (D50) of greater than about 10 μm to less than about 15 μm.

The wollastonite may have an average length of about 100 μm to about 300 μm.

The wollastonite may have an average aspect ratio (length/diameter) of about 11 to about 25.

The polyester resin may include a repeat unit represented by the following Formula 1:

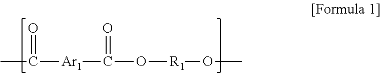

wherein Ar₁ is a substituted or unsubstituted C₆ to C₁₈ arylene group and R₁ is a C₁ to C₂₀ linear alkylene group or a C₃ to C₂₀ branched alkylene group.

The polyester resin may optionally further include about 40 mol % or less of a repeat unit represented by the following Formula 2:

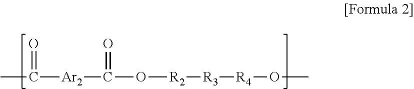

wherein Ar₂ is a substituted or unsubstituted C₆ to C₁₈ arylene group; R₂ and R₄ are the same or different and are each independently a single bond, a C₁ to C₂₀ linear alkylene group, or a C₃ to C₂₀ branched alkylene group; and R₃ is a C₃ to C₂₀ cyclic alkylene group.

The polyester resin may have an inherent viscosity of about 0.5 dl/g to about 1.5 dl/g, as measured at 35° C. using an o-chlorophenol solution (concentration: about 0.5 g/dl).

The thermoplastic resin composition may further include at least one additive selected from among antimicrobial agents, heat stabilizers, release agents, photostabilizers, dyes, surfactants, coupling agents, plasticizers, admixtures, lubricants, antistatic agents, pigments, toners, flame retardants, colorants, UV absorbers, UV blocking agents, fillers, nucleating agents, bonding aids, adhesives, and mixtures thereof.

Another embodiment of the present invention relates to a molded article including the thermoplastic resin composition as set forth above.

The molded article may have a flexural modulus of about 40,000 kgf/cm² or more, as measured on a 6.4 mm thick specimen in accordance with ASTM D790.

The molded article may have a shrinkage rate of about 0.5 or less, as measured on a 3.2 mm thick circular specimen having a diameter of 100 mm in a resin flow direction in accordance with ASTM D955.

The molded article may have a rib strength of about 100 N or more, as measured on a plate-shaped specimen having a size of 120 mm×180 mm×3 mm, with a 1 mm thick rib having a height of 25 mm and placed at a distance of 20 mm from a gate, by pushing the rib at a speed of 1 mm/s until the rib is fractured.

### DETAILED DESCRIPTION

The above and other aspects, features, and advantages of the present invention will become apparent from the detailed description of the following embodiments. It should be understood that the present invention is not limited to the following embodiments and may be embodied in different ways, and that the embodiments are provided for complete disclosure and thorough understanding of the present invention by those skilled in the art. The scope of the present invention should be defined only by the appended claims.

As used herein, the term “average aspect ratio” refers to a ratio (a/b) of average length (a) of wollastonite to average particle diameter (D50) (b) thereof Hereinafter, a thermoplastic resin composition according to the present invention will be described in detail.

A thermoplastic resin composition according to exemplary embodiments of the present invention includes about 100 parts by weight of a base resin including about 60% by weight (wt %) to about 85 wt % of a polycarbonate resin and about 15 wt % to about 40 wt % of a polyester resin; and about 10 parts by weight to about 25 parts by weight of wollastonite, wherein the wollastonite has an average particle diameter (D50) of greater than about 10 μm to less than about 15 μm.

Base Resin

Polycarbonate Resin

The polycarbonate resin may be a polycarbonate resin used in a typical thermoplastic resin composition. For example, the polycarbonate resin may be an aromatic polycarbonate resin prepared by reacting one or more diphenols (for example, aromatic diol compounds) with a precursor, such as phosgene, halogen formate, and carbonic diester.

Examples of the diphenols may include without limitation 4,4′-biphenol, 2,2-bis(4-hydroxyphenyl)propane, 2,4-bis(4-hydroxyphenyl)-2-methylbutane, 1,1-bis(4-hydroxyphenyl)cyclohexane, 2,2-bis(3-methyl-4-hydroxyphenyl)propane, 2,2-bis(3,5-dimethyl-4-hydroxyphenyl)propane, 2,2-bis(3-chloro-4-hydroxyphenyl)propane, 2,2-bis(3,5-dichloro-4-hydroxyphenyl)propane, and the like, and mixtures thereof. For example, the diphenol(s) may include 2,2-bis(4-hydroxyphenyl)propane, 2,2-bis(3,5-dichloro-4-hydroxyphenyl)propane, 2,2-bis(3-methyl-4-hydroxyphenyl)propane, 2,2-bis(3,5-dimethyl-4-hydroxyphenyl)propane, and/or 1,1-bis(4-hydroxyphenyl)cyclohexane, for example, 2,2-bis(4-hydroxyphenyl)propane, which is also referred to as bisphenol A.

The polycarbonate resin may be a branched polycarbonate resin. For example, the polycarbonate resin may be a branched polycarbonate resin prepared by adding a tri- or higher polyfunctional compound, for example, a tri- or higher valent phenol group-containing compound, in an amount of about 0.05 mol % to about 2 mol % based on the total number of moles of the diphenols used in polymerization.

The polycarbonate resin may be a homopolycarbonate resin, a copolycarbonate resin, or a blend thereof.

In addition, the polycarbonate resin may be partly or completely replaced by an aromatic polyester-carbonate resin obtained through polymerization in the presence of an ester precursor, for example, a bifunctional carboxylic acid.

The polycarbonate resin may have a weight average molecular weight (Mw) of about 15,000 g/mol or more, for example, about 15,000 g/mol to about 100,000 g/mol, for example about 17,000 g/mol to about 60,000 g/mol, and as another example about 20,000 g/mol to about 40,000 g/mol, as measured by gel permeation chromatography (GPC). The polycarbonate resin may be a mixture of polycarbonate resins having different weight average molecular weights. Within this range of weight average molecular weights of the polycarbonate resin, a molded article formed of the thermoplastic resin composition can exhibit good properties in terms of external appearance and flexural modulus.

The polycarbonate resin may have a melt-flow index (MI) of about 5 to about 40 g/10 min as measured under conditions of 250° C. and 10 kg in accordance with ISO 1133, without being limited thereto.

The base resin can include the polycarbonate resin in an amount of about 60 wt % to about 85 wt %, for example about 60 wt % to about 80 wt %, and as another example about 65 wt % to about 80 wt %, based on the total weight (100 wt %) of the polycarbonate resin and the polyester resin of the base resin. In some embodiments, the base resin can include the polycarbonate resin in an amount of about 60, 61, 62, 63, 64, 65, 66, 67, 68, 69, 70, 71, 72, 73, 74, 75, 76, 77, 78, 79, 80, 81, 82, 83, 84, or 85 wt %. Further, according to some embodiments, the amount of the polycarbonate resin can be in a range from about any of the foregoing amounts to about any other of the foregoing amounts.

Within this range, a molded article formed of the thermoplastic resin composition can exhibit good properties in terms of external appearance and flexural modulus.

Polyester Resin

According to the present invention, the polyester resin may include a repeat unit represented by the following Formula 1:

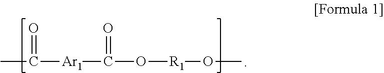

In Formula 1, An is a substituted or unsubstituted C₆ to C₁₈ arylene group, for example a substituted or unsubstituted C₆ to C₁₂ arylene group, and as another example a substituted or unsubstituted C₆ to C₁₀ arylene group; and R₁ is a C₁ to C₂₀ linear alkylene group or a C₃ to C₂₀ branched alkylene group, for example a C₁ to C₁₀ linear alkylene group or C₃ to C₁₂ branched alkylene group, and as another example a C₁ to C₅ linear alkylene group or C₃ to C₇ branched alkylene group.

The polyester resin can increase flowability of the thermoplastic resin composition, which can improve external appearance, processability and compatibility of a molded article formed of the thermoplastic resin composition.

The repeat unit represented by Formula 1 may be obtained through polymerization of a dicarboxylic acid component including an aromatic dicarboxylic acid and a diol component including a C₁ to C₂₀ linear alkylene group or a C₃ to C₂₀ branched alkylene group.

The dicarboxylic acid component may include an aromatic dicarboxylic acid and/or aromatic dicarboxylate used in a typical polyester resin, for example, a C₈ to C₂₀ aromatic dicarboxylic acid and/or aromatic dicarboxylate. In addition, the dicarboxylic acid component may further include a linear and/or cyclic aliphatic dicarboxylic acid, as needed.

Examples of the aromatic dicarboxylic acid may include without limitation terephthalic acid (TPA), isophthalic acid (IPA), phthalic acid, 1,2-naphthalene dicarboxylic acid, 1,4-naphthalene dicarboxylic acid, 1,5-naphthalene dicarboxylic acid, 1,6-naphthalene dicarboxylic acid, 1,7-naphthalene dicarboxylic acid, 1,8-naphthalene dicarboxylic acid, 2,3-naphthalene dicarboxylic acid, 2,6-naphthalene dicarboxylic acid, and 2,7-naphthalene dicarboxylic acid; and examples of the aromatic dicarboxylates can include without limitation dimethyl terephthalate (DMT), dimethyl isophthalate, dimethyl-1,2-naphthalate, dimethyl-1,5-naphthalate, dimethyl-1,7-naphthalate, dimethyl-1,7-naphthalate, dimethyl-1,8-naphthalate, dimethyl-2,3-naphthalate, dimethyl-2,6-naphthalate, and dimethyl-2,7-naphthalate. These may be used alone or in combination thereof. For example, terephthalic acid can be used.

The diol component may include a diol including a C₁ to C₂₀ linear alkylene group or a C₃ to C₂₀ branched alkylene group. Example of the diol including a C₁ to C₂₀ linear alkylene group or a C₃ to C₂₀ branched alkylene group may include without limitation ethylene glycol, 1,3-propane-diol, 1,3-butanediol, 1,4-butanediol, 1,4-pentanediol, 1,5-pentanediol, 1,6-hexanediol, 3-methylpentane-2,4-diol, 2-methylpentane-1,4-diol, 2,2,4-trimethylpentane-1,3-diol, 2-ethylhexane-1,3-diol, 2,2-diethylpropane-1,3-diol, and the like, and mixtures thereof.

In another embodiment, the polyester resin may optionally further include about 40 mol % or less, for example about 30 mol % or less, and as another example about 20 mol % or less of a repeat unit represented by the following Formula 2:

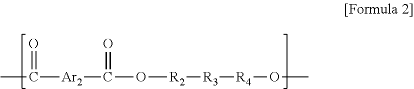

wherein in Formula 2, Ar₂ is a substituted or unsubstituted C₆ to C₁₈ arylene group, for example a substituted or unsubstituted C₆ to C₁₂ arylene group, and as another example a substituted or unsubstituted C₆ to C₁₀ arylene group; R₂ and R₄ are the same or different and are each independently a single bond, a C₁ to C₂₀ linear alkylene group or a C₃ to C₂₀ branched alkylene group, for example a single bond, a C₁ to C₁₀ linear alkylene group or a C₃ to C₁₂ branched alkylene group, and as another example a single bond, a C₁ to C₅ linear alkylene group or a C₃ to C₇ branched alkylene group; and R₃ is a C₃ to C₂₀ cyclic alkylene group, for example a C₃ to C₁₅ cyclic alkylene group, and as another example a C₃ to C₁₀ cyclic alkylene group.

In some embodiments, the polyester resin can include the repeat unit represented by Formula 2 in an amount of 0 (the repeat unit represented by Formula 2 is not present), about 0 (the repeat unit represented by Formula 2 is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 mol %. Further, according to some embodiments, the amount of the repeat unit represented by Formula 2 can be in a range from about any of the foregoing amounts to about any other of the foregoing amounts.

Within this range, the polyester resin can improve miscibility between the components of the thermoplastic resin composition, which can further improve properties of a molded article formed of the thermoplastic resin composition such as impact resistance, dimensional stability, external appearance, and the like.

The repeat unit represented by Formula 2 may be obtained through polymerization of a dicarboxylic acid component including an aromatic dicarboxylic acid and a diol component including a C₃ to C₂₀ cyclic alkylene group. The aromatic dicarboxylic acid component may be substantially the same as the dicarboxylic acid component used in Formula 1.

The diol component may include a diol including a C₃ to C₂₀ cyclic alkylene group. Examples of the diol including a C₃ to C₂₀ cyclic alkylene group may include without limitation 1,4-cyclohexanediol, 1,4-cyclohexanedimethanol (CHDM), 1,4-cyclohexanediethanol, 1,4-cyclohexanedipropanol, 1,4-cyclohexanedibutanol, 1,4-cyclohexanolmethanol, 1,4-cyclohexanolethanol, 1,4-cyclohexanolpropanol, 1,4-cyclohexanolbutanol, 1,4-cyclohexanemethanolethanol, 1,4-cyclohexanemethanolpropanol, 1,4-cyclohexanemethanolbutanol, 1,4-cyclohexaneethanolpropanol, 1,4-cyclohexaneethanolbutanol, 1,4-cyclohexanepropanolbutanol, 1,3-cyclohexanediol, 1,3-cyclohexanedimethanol (CHDM), 1,3-cyclohexanediethanol, 1,3-cyclohexanedipropanol, 1,3-cyclohexanedibutanol, 1,3-cyclohexanolmethanol, 1,3-cyclohexanolethanol, 1,3-cyclohexanolpropanol, 1,3-cyclohexanolbutanol, 1,3-cyclohexanemethanolethanol, 1,3-cyclohexanemethanolpropanol, 1,3-cyclohexanemethanolbutanol, 1,3-cyclohexaneethanolpropanol, 1,3-cyclohexaneethanolbutanol, 1,3-cyclohexanepropanolbutanol, 1,2-cyclohexanediol, 1,2-cyclohexanedimethanol (CHDM), 1,2-cyclohexanediethanol, 1,2-cyclohexanedipropanol, 1,2-cyclohexanedibutanol, 1,2-cyclohexanolmethanol, 1,2-cyclohexanolethanol, 1,2-cyclohexanolpropanol, 1,2-cyclohexanolbutanol, 1,2-cyclohexanemethanolethanol, 1,2-cyclohexanemethanolpropanol, 1,2-cyclohexanemethanolbutanol, 1,2-cyclohexaneethanolpropanol, 1,2-cyclohexaneethanolbutanol, 1,2-cyclohexanepropanolbutanol, and the like, and mixtures thereof.

In exemplary embodiments, the polyester resin may be prepared through polycondensation of the dicarboxylic acid component and the diol component including the diol including a C₁ to C₂₀ linear alkylene group or a C₃ to C₂₀ branched alkylene group, and optionally, the diol including a C₃ to C₂₀ cyclic alkylene group. With these components, the thermoplastic resin composition can have the aforementioned effects.

The polyester resin may have an inherent viscosity of about 0.5 dl/g to about 1.5 dl/g, for example, about 0.6 dl/g to about 1.4 dl/g, as measured at 35° C. using an o-chlorophenol solution (concentration: 0.5 g/dl). Within this range of viscosity, the polyester resin can improve miscibility between the components of the thermoplastic resin composition, which can further improve properties to a molded article formed of the thermoplastic resin composition such as impact resistance, flowability, dimensional stability, external appearance, and the like.

The base resin can include the polyester resin in an amount of about 15 wt % to about 40 wt %, for example about 20 wt % to about 40 wt %, and as another example about 20 wt % to about 35 wt %, based on the total weight (100 wt %) of the polycarbonate resin and the polyester resin of the base resin. In some embodiments, the base resin can include the polyester resin in an amount of about 15, 16, 17, 18, 19, 20, 21, 22, 23, 24, 25, 26, 27, 28, 29, 30, 31, 32, 33, 34, 35, 36, 37, 38, 39, or 40 wt %. Further, according to some embodiments of the present invention, the polyester resin can be present in an amount of from about any of the foregoing amounts to about any other of the foregoing amounts.

Within this range, a molded article formed of the thermoplastic resin composition can have a good balance between thermal resistance and flowability.

Wollastonite

According to the present invention, wollastonite may have an acicular shape and may have an average particle diameter (D50) of greater than about 10 μm to less than about 15 μm, for example about 11 μm to about 14 μm. As used herein, the average (median) particle size means an average particle size (D50) based on volume measured by a laser diffraction analyzer, for example, a laser diffraction analyzer S3500 by Microtrac Inc.

The wollastonite may have an average (median) length of about 100 μm to about 300 μm, for example about 100 μm to about 200 μm. In some embodiments, the wollastonite may have an average length of about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, about 250 μm, about 260 μm, about 270 μm, about 280 μm, about 290 μm, or about 300 μm. Further, the average length of the wollastonite may range from one of the numerical values set forth above to another numerical value set forth above.

The wollastonite may have an average aspect ratio (length/diameter) of about 11 to about 25, for example about 11 to about 20. In some embodiments, the wollastonite may have an average aspect ratio (length/diameter) of about 11, 12, 13, 14, 15, 16, 17, 18, 19, 20, 21, 22, 23, 24 or 25. Furthermore, the average aspect ratio of the wollastonite may range from one of the numerical values set forth above to another numerical value set forth above.

As used herein, the average aspect ratio (length/diameter) refers to a ratio (a/b) of the average length (a) of the wollastonite to the average particle diameter (D50) (b) thereof. Within this range of the average aspect ratio of the wollastonite, a molded article formed of the thermoplastic resin composition can exhibit good properties such as flexural modulus, dimensional stability and impact resistance.

The wollastonite may be subjected to surface treatment, for example with a silane coupling agent, a long-chain fatty acid, a long-chain aliphatic alcohol, and the like. Examples of a material for surface treatment may include without limitation vinyl silane compounds, such as vinyltriethoxysilane and vinyltrichlorosilane; epoxy silane compounds, such as γ-glycidoxypropyltrimethoxysilane, γ-glycidoxypropyltriethoxysilane, β-(3,4-epoxy cyclohexyl)ethyltrimethoxysilane; amino silane compounds, such as γ-(2-aminoethyl)aminopropylmethyldimethoxysane, γ-(2-aminoethyl)aminopropyltrimethoxysilane, and γ-aminopropyltrimethoxysilane; long-chain fatty acids, such as stearic acid, oleic acid, and montanic acid; and/or long-chain aliphatic alcohols, such as stearyl alcohol.

The thermoplastic resin composition can include the wollastonite in an amount of about 10 parts by weight to about 25 parts by weight, for example about 10 parts by weight to about 20 parts by weight, and as another example about 10 parts by weight to about 15 parts by weight, based on about 100 parts by weight of the base resin including the polycarbonate resin and the polyester resin. In some embodiments, the thermoplastic resin composition can include the wollastonite in an amount of about 10, 11, 12, 13, 14, 15, 16, 17, 18, 19, 20, 21, 22, 23, 24, or 25 parts by weight. Further, according to some embodiments of the present invention, the wollastonite can be present in an amount of from about any of the foregoing amounts to about any other of the foregoing amounts.

Within this range of the wollastonite, a molded article formed of the thermoplastic resin composition can exhibit good properties such as flexural modulus, dimensional stability and impact resistance.

Additive(s)

The thermoplastic resin composition according to the present invention may further include at least one or more additives selected from among antimicrobial agents, heat stabilizers, release agents, photostabilizers, dyes, surfactants, coupling agents, plasticizers, admixtures, lubricants, antistatic agents, pigments, toners, flame retardants, colorants, UV absorbers, UV blocking agents, fillers (excluding wollastonite having an average particle diameter of greater than about 10 μm to less than about 15 μm), nucleating agents, bonding aids, adhesives, and the like, and mixtures thereof, as needed.

The amount of the additive may be determined by the skilled artisan without undue experimentation depending upon purposes of the thermoplastic resin composition so as not to deteriorate the properties thereof.

The thermoplastic resin composition according to embodiments of the present invention may be prepared by a typical method known in the art. For example, the thermoplastic resin composition may be prepared in pellet form by mixing the above components and optional additive(s) using a Henschel mixer, a V blender, a tumbler blender, or a ribbon blender, followed by melt extrusion at about 200° C. to about 350° C. in a single-screw extruder or a twin-screw extruder. For example, the thermoplastic resin composition may be prepared in pellet form by extruding the mixture of the components and the optional additive(s) at about 250° C. to about 310° C. using a twin screw extruder.

A molded article according to the present invention is produced from the thermoplastic resin composition. For example, the molded article may be produced from the thermoplastic resin composition by a method known in the art, for example, injection molding, blow molding, extrusion molding, casting molding, or the like.

The molded article may have a flexural modulus of about 40,000 kgf/cm² or more, for example, about 40,000 kgf/cm² to about 60,000 kgf/cm², and as another example about 42,000 kgf/cm² to about 55,000 kgf/cm², as measured on a 6.4 mm thick specimen in accordance with ASTM D790. Within this range, the molded article can have good dimensional stability.

The molded article may have a shrinkage rate of about 0.5 or less, as measured on a 3.2 mm thick circular specimen having a diameter of 100 mm in a resin flow direction in accordance with ASTM D955. Within this range, the molded article can have good dimensional stability.

The molded article may have a rib strength of about 100 N or more, for example, about 100 N to about 300 N, as another example about 105 N to about 250 N, and as another example about 110 N to about 200 N, as measured on a plate-shaped specimen having a size of 120 mm×180 mm×3 mm, with a 1 mm thick rib having a height of 25 mm placed at a distance of 20 mm from a gate, by pushing the rib at 1 mm/sec until the rib is fractured. Within this range, the molded article can be suitable for use as various interior/exterior components.

Next, the present invention will be described in more detail with reference to the following examples. It should be understood that these examples are provided for illustration only and are not to be construed in any way as limiting the present invention.

Descriptions of details apparent to those skilled in the art will be omitted.

### EXAMPLES

Details of components used in Examples and Comparative Examples are as follows.

(A) Polycarbonate resin

(a1) An INFINO® series product (Samsung SDI Co., Ltd.) having a weight average molecular weight of 27,000 is used.

(a2) An INFINO® series product (Samsung SDI Co., Ltd.) having a weight average molecular weight of 24,000 is used.

(B) Polyester resin

(b1) SKYPET BB-8055 (SK Chemicals Co., Ltd.) having an inherent viscosity of 0.8 dl/g, as measured at 35° C. using an o-chlorophenol solution (concentration: 0.5 g/dl), is used.

(b2) SHINITE DHK011 (Shinkong Synthetic Fibers Corp.) having an inherent viscosity of 1.1 dl/g, as measured at 35° C. using an o-chlorophenol solution (concentration: 0.5 g/dl), is used.

(C) Wollastonite (produced by NYCO Minerals Inc.) having an average particle diameter (D50) of 12 μm, an average length 156 μm and an average aspect ratio (length/diameter) of 13 is used.

(C′-1) Wollastonite (produced by NYCO Minerals Inc.) having an average particle diameter (D50) of 7 μm, an average length 63 μm and an average aspect ratio of 9 is used.

(C′-2) Wollastonite (produced by NYCO Minerals Inc.) having an average particle diameter (D50) of 15 μm, an average length 150 μm and an average aspect ratio of 10 is used.

(D) Talc: Jetfine 3CA (IMERYS Co., Ltd.) is used.

(E) Kaolin: 95 Cl (Australian China Clays Ltd.) is used.

### Example 1

100 parts by weight of the base resin comprising 70 wt % of the polycarbonate resin (a1), 10 wt % of the polycarbonate resin (a2), and 20 wt % of the polyester resin (b1) are mixed with 15 parts by weight of wollastonite (C), followed by extrusion at 260° C. using a twin-screw extruder (L/D=29, Φ=36 mm), thereby preparing a thermoplastic resin composition in pellet form.

### Examples 2 and 3 and Comparative Examples 1 to 5

Thermoplastic resin compositions are prepared in pellet form in the same manner as in Example 1 except for using the types and amounts of composition components listed in Table 1.

TABLE 1

| | | Example | | | Comparative Example | | | | |
|---|---|---|---|---|---|---|---|---|---|
| | | 1 | 2 | 3 | 1 | 2 | 3 | 4 | 5 |
| ( A) | (a1) | 70 | 60 | 65 | 70 | 70 | 70 | 70 | 55 |
| | (a2) | 10 | 20 | — | — | 10 | 10 | 10 | — |
| ( B) | (b1) | 20 | — | 35 | — | 20 | 20 | 20 | 45 |
| | (b2) | — | 20 | — | 30 | — | — | — | — |

| | | | | | | | | |
|---|---|---|---|---|---|---|---|---|
| Total (wt %) | 100 | 100 | 100 | 100 | 100 | 100 | 100 | 100 |
| (C) (parts by | 15 | 15 | 20 | — | — | — | — | 20 |
| weight) | | | | | | | | |
| (C′-1) (parts by | — | — | — | — | — | 15 | — | — |
| weight) | | | | | | | | |
| (C′-2) (parts by | — | — | — | — | — | — | 15 | — |
| weight) | | | | | | | | |
| (D) (parts by | — | — | — | 15 | — | — | — | — |
| weight) | | | | | | | | |
| (E) (parts by | — | — | — | — | 15 | — | — | — |
| weight) | | | | | | | | |

Specimens are produced using the resin composition of the Examples and Comparative Examples and evaluated as to the following properties. Evaluation results are shown in Table 2.

Evaluation of Properties

Preparation of specimen: The resin compositions prepared in pellet form are dried in an oven at 100° C. for 3 hours or more and are injection-molded using a 10 oz. injection molding machine at a molding temperature of 250° C. to 270° C. and a mold temperature of 60° C. to 80° C., thereby producing specimens for property evaluation in accordance with the corresponding standards for property evaluation.

(1) Impact resistance (rib strength, N): Rib strength is measured with respect to a plate-shaped specimen having a size of 3 mm×120 mm×180 mm, with a 1 mm thick rib having a height of 25 mm placed at a distance of 20 mm from a gate, by pushing the rib at 1 mm/sec until the rib is fractured.

(2) Stiffness (flexural modulus, kgf/cm²): A specimen having a size of 6.4 mm×12.7 mm×125 mm is prepared by the above method and measured as to flexural modulus in accordance with ASTM D790.

(3) Dimensional stability (Shrinkage rate): Shrinkage rate is measured with respect to a 3.2 mm thick circular specimen having a diameter of 100 mm in a resin flow direction in accordance with ASTM D955.

(4) External appearance: External appearance of a molded article having a size of 3.2 mm×100 mm×100 mm and produced by injection molding is observed with the naked eye, and evaluated according to the following evaluation standard:

◯: No protrusion of inorganic materials on surface and gloss,

Δ: Some protrusions of inorganic materials on surface and low gloss,

×: Severe protrusion of inorganic materials on surface.

TABLE 2

| | Example | | | Comparative Example | | | | |
|---|---|---|---|---|---|---|---|---|
| | 1 | 2 | 3 | 1 | 2 | 3 | 4 | 5 |
| Rib strength | 110 | 123 | 115 | 95 | 80 | 95 | 120 | 70 |
| Flexural | 42,000 | 42,000 | 45,000 | 33,000 | 32,000 | 32,000 | 42,000 | 33,000 |
| modulus | | | | | | | | |
| Shrinkage rate | 0.4 | 0.5 | 0.3 | 0.4 | 0.6 | 0.6 | 0.4 | 0.6 |
| External | ∘ | ∘ | ∘ | ∘ | Δ | ∘ | x | ∘ |
| appearance | | | | | | | | |

As shown in Table 2, the thermoplastic resin compositions of the Examples exhibit good properties in terms of not only impact resistance, stiffness and external appearance, but also dimensional stability. Conversely, the thermoplastic resin compositions of the Comparative Examples fail to exhibit improvement in such properties.

Although some embodiments have been described above, it should be understood that these embodiments are provided for illustration only and are not to be construed in any way as limiting the present invention, and that various modifications, changes, and alterations can be made by those skilled in the art without departing from the spirit and scope of the invention. Therefore, the scope of the present invention should be defined by the appended claims and equivalents thereof.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A thermoplastic resin composition comprising:
about 100 parts by weight of a base resin comprising about 60 wt % to about 85 wt % of a polycarbonate resin and about 15 wt % to about 40 wt % of a polyester resin; and
about 10 parts by weight to about 25 parts by weight of wollastonite,
wherein the wollastonite has an average particle diameter (D50) of greater than about 10 μm to less than about 15 μm.

2. The thermoplastic resin composition according to claim 1, wherein the wollastonite has an average length of about 100 μm to about 300 μm.

3. The thermoplastic resin composition according to claim 2, wherein the wollastonite has an average aspect ratio (length/diameter) of about 11 to about 25.

4. The thermoplastic resin composition according to claim 1, wherein the polyester resin comprises a repeat unit represented by Formula 1: 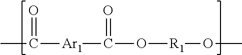
wherein An is a substituted or unsubstituted C₆ to C₁₈ arylene group and R₁ is a C₁ to C₂₀ linear alkylene group or a C₃ to C₂₀ branched alkylene group.

5. The thermoplastic resin composition according to claim 4, wherein the polyester resin optionally further comprises about 40 mol % or less of a repeat unit represented by Formula 2: 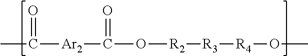
wherein Ar₂ is a substituted or unsubstituted C₆ to C₁₈ arylene group; R₂ and R₄ are the same or different and are each independently a single bond, a C₁ to C₂₀ linear alkylene group or a C₃ to C₂₀ branched alkylene group; and R₃ is a C₃ to C₂₀ cyclic alkylene group.

6. The thermoplastic resin composition according to claim 1, wherein the polyester resin has an inherent viscosity of about 0.5 dl/g to about 1.5 dl/g, as measured at 35° C. using an o-chlorophenol solution (concentration: 0.5 g/dl).

7. The thermoplastic resin composition according to claim 1, further comprising:
at least one additive selected from the group consisting of antimicrobial agents, heat stabilizers, release agents, photostabilizers, dyes, surfactants, coupling agents, plasticizers, admixtures, lubricants, antistatic agents, pigments, toners, flame retardants, colorants, UV absorbers, UV blocking agents, fillers, nucleating agents, bonding aids, adhesives, and mixtures thereof.

8. A molded article comprising the thermoplastic resin composition according to claim 1.

9. The molded article according to claim 8, wherein the molded article has a flexural modulus of about 40,000 kgf/cm² or more, as measured on a 6.4 mm thick specimen in accordance with ASTM D790.

10. The molded article according to claim 8, wherein the molded article has a shrinkage rate of about 0.5 or less, as measured on a 3.2 mm thick circular specimen having a diameter of 100 mm in a resin flow direction in accordance with ASTM D955.

11. The molded article according to claim 8, wherein the molded article has a rib strength of about 100 N or more, as measured on a plate-shaped specimen having a size of 120 mm×180 mm×3 mm, with a 1 mm thick rib having a height of 25 mm placed at a distance of 20 mm from a gate, by pushing the rib at 1 mm/sec until the rib is fractured.
